(19) United States
(12) Patent Application Publication
(10) Pub. No.: US 2025/0355178 A1
(43) Pub. Date: Nov. 20, 2025

(54) GLASS SUBSTRATE AND OPTICAL INTEGRATED DEVICE

(71) Applicant: AGC Inc., Tokyo (JP)

(72) Inventors: Kazuki KANEHARA, Tokyo (JP); Seiki OHARA, Tokyo (JP)

(73) Assignee: AGC Inc., Tokyo (JP)

(21) Appl. No.: 19/285,414

(22) Filed: Jul. 30, 2025

Related U.S. Application Data
(63) Continuation of application No. PCT/JP2024/002112, filed on Jan. 24, 2024.

(30) Foreign Application Priority Data
Jan. 31, 2023 (JP) 2023-013069

(51) Int. Cl. G02B 6/122; C03C 3/078; C03C 3/085; C03C 3/087; C03C 3/091; G02B 6/12

(52) U.S. Cl. CPC G02B 6/1223; C03C 3/078; C03C 3/085; C03C 3/087; C03C 3/091; G02B 2006/12038

(57) ABSTRACT

A glass substrate includes: a core portion to be an optical waveguide; and a cladding portion. The core portion and the cladding portion both include a glass, the core portion has a higher Ag concentration than the cladding portion, a Ag concentration gradient is present from a boundary between the core portion and the cladding portion toward a region in the core portion where the Ag concentration is maximum, the core portion is a region where a refractive index is equal to or greater than a value represented by {N+(Δn/2)}, where Δn is a refractive index difference represented by (Nmax−N), the refractive index difference Δn is 0.005 or more, and a core thickness Δd of the core portion in a thickness direction of the glass substrate is 2.5 μm to 10 μm.

### CROSS-REFERENCE TO RELATED APPLICATIONS

This is a bypass continuation of International Application No. PCT/JP2024/002112 filed on Jan. 24, 2024, and claims priority from Japanese Patent Application No. 2023-013069 filed on Jan. 31, 2023, the entire content of which is incorporated herein by reference.

### TECHNICAL FIELD

The present invention relates to a glass substrate and an optical integrated device using the glass substrate.

### BACKGROUND ART

In recent years, a high-speed large-capacity transmission technique has attracted attention, starting with 5G and 6G wireless transmission such as microwaves and millimeter waves. In order to realize larger capacity and lower delay transmission, an “optoelectric fusion technique” has been studied in which a part of communication that has been electrically performed inside a personal computer or the like is optically performed.

By using an optical signal instead of an electric signal, low power consumption, large capacity communication, and low delay transmission are expected.

In the optoelectric fusion technique, a substrate capable of transmitting both electricity and light is required. As such a substrate, various materials have been studied, such as a Si—Ge substrate in which SiO₂ is doped with Ge, a Si thin wire substrate in which Si is surrounded by SiO₂, and a polymer-based substrate in which different kinds of polymers are bonded.

On the other hand, a substrate using a glass material has begun to be studied from the viewpoint of heat resistance, rigidity, a degree of integration of transmission lines for telecommunication, cost, and the like.

For example, Patent Literature 1 discloses that an optical waveguide can be formed by ion exchange of Na ions in a glass with Ag ions.
Patent Literature 1: JP2021-511538A
Patent Literature 2: JP7059993B

### SUMMARY OF INVENTION

A technique for ion exchange of ions in the glass with other ions is known as a technique for mainly increasing a strength of the glass, as shown in, for example, Patent Literature 2.

With respect to this, as a result of studies by the inventors of the present invention, it has been found that it is difficult to obtain a stable optical waveguide that realizes control of a core thickness and high homogeneity even when the optical waveguide is formed using the ion exchange technique in the related art as described above. In particular, it is difficult to form an optical waveguide that can cope with light propagated in a single mode.

Therefore, an object of the present invention is to provide a glass substrate having an optical waveguide capable of coping with light propagated in a single mode.

As a result of further studies by the inventors of the present invention, it has been found that the ion exchange technique in the related art for increasing the strength of the glass has a very high ion exchange rate, and thus it is difficult to control a thickness of a core to be an optical waveguide or to realize high homogeneity. Therefore, a method of reducing the ion exchange rate to an appropriate rate has been found, and a glass substrate capable of solving the above problems has been obtained. Thus, the present invention has been completed.

That is, the present invention relates to the following [1] to [11].

[1] A glass substrate including:
a core portion to be an optical waveguide; and
a cladding portion,
in which the core portion and the cladding portion both include a glass,
the core portion has a higher Ag concentration than the cladding portion,
a Ag concentration gradient is present from a boundary between the core portion and the cladding portion toward a region in the core portion where the Ag concentration is maximum,
the core portion is a region where a refractive index is equal to or greater than a value represented by {N+(Δn/2)}, where Δn is a refractive index difference represented by (Nmax−N), Nmax is a maximum value of a refractive index in the core portion, and N is a refractive index of the cladding portion,
the refractive index difference Δn is 0.005 or more, and
a core thickness Δd of the core portion in a thickness direction of the glass substrate is 2.5 μm to 10 μm.

[2] The glass substrate according to [1], in which the glass of the cladding portion satisfies the following contents in mol % in terms of oxides: 45% to 80% of SiO₂, 0% to 15% of Al₂O₃, 0% to 20% of B₂O₃, 10% to 30% of MgO, CaO, SrO, and BaO in total, and 4.5% to 25% of Na₂O, and
the glass of the core portion satisfies the following contents in mol % in terms of oxides: 45% to 80% of SiO₂, 0% to 15% of Al₂O₃, 0% to 20% of B₂O₃, 10% to 30% of MgO, CaO, SrO, and BaO in total, 0% to 20% of Na₂O, and 0.01% or more of Ag₂O.

[3] The glass substrate according to [1] or [2], in which the glass of the cladding portion has a value represented by (MgO+CaO+SrO×2+BaO×2−Al₂O₃×2) of 0% to 30%, using contents in mol % in terms of oxides.

[4] The glass substrate according to any one of [1] to [3], in which the glass of the cladding portion has a value represented by (MgO+CaO×2+SrO×3+BaO×4−Al2O3×2) of 0% to 60%, using contents in mol % in terms of oxides.

[5] The glass substrate according to any one of [1] to [4], in which the glass of the cladding portion has a value represented by {Na₂O/(MgO+CaO×2+SrO×3+BaO×4)} of 0.1 to 0.7, using contents in mol % in terms of oxides.

[6] The glass substrate according to any one of [1] to [5], in which the glass of the cladding portion has a value represented by {Na₂O/(MgO+CaO×2+SrO×3+BaO×4−Al₂O₃)} of 0.1 to 2, using contents in mol % in terms of oxides.

[7] The glass substrate according to any one of [1] to [6], having a thickness of 100 μm to 2000 μm.

[8] The glass substrate according to any one of [1] to [7], in which a propagation loss amount of light having a wavelength of 1200 nm to 1600 nm in the core portion is 5.0 dB/cm or less at maximum.

[9] The glass substrate according to any one of [1] to [8], in which the refractive index difference Δn is 0.007 or more.

[10] The glass substrate according to any one of [1] to [9], in which the core thickness Δd is 3 μm to 6 μm.

[11] An optical integrated device including:
the glass substrate according to any one of [1] to [10]; and
a semiconductor substrate connected to the glass substrate,
in which light propagated in a single mode is introduced into the semiconductor substrate via the core portion of the glass substrate.

The glass substrate according to the present invention has an optical waveguide capable of coping with light propagated in a single mode. Therefore, it is also suitable as a glass substrate having an optical waveguide for introducing light propagated in a single mode into a photonics substrate in the optical integrated device.

### BRIEF DESCRIPTION OF DRAWINGS

FIG. 1 is a schematic view illustrating a core portion and a cladding portion in a glass substrate.

FIG. 2 is a diagram illustrating a refractive index maximum value Nmax, a refractive index N, a refractive index difference Δn, and a core thickness Δd.

FIG. 3 is a graph showing a relationship between a value represented by (MgO+CaO+SrO×2+BaO×2−Al₂O₃×2) in a glass composition of the cladding portion in the glass substrate and a Ag ion penetration depth after an ion exchange treatment is performed.

FIG. 4 is a graph showing a relationship between a value represented by (MgO+CaO×2+SrO×3+BaO×4−Al₂O₃×2) in the glass composition of the cladding portion in the glass substrate and the Ag ion penetration depth after an ion exchange treatment is performed.

FIG. 5 is a graph showing a relationship between a value represented by {Na₂O/(MgO+CaO×2+SrO×3+BaO×4)} in the glass composition of the cladding portion in the glass substrate and the Ag ion penetration depth after an ion exchange treatment is performed.

FIG. 6 is a graph showing a relationship between a value represented by {Na₂O/(MgO+CaO×2+SrO×3+BaO×4−Al₂O₃)} in the glass composition of the cladding portion in the glass substrate and the Ag ion penetration depth after an ion exchange treatment is performed.

### DESCRIPTION OF EMBODIMENTS

Hereinafter, the present invention is described in detail, but the present invention is not limited to the following embodiment and can be freely modified and implemented without departing from the gist of the present invention. In addition, “to” indicating a numerical range is used to include numerical values written before and after it as a lower limit value and an upper limit value.

### Glass Substrate

A glass substrate according to the present embodiment includes a core portion to be an optical waveguide and a cladding portion, and the core portion and the cladding portion are both made of a glass.

The core portion has a higher Ag concentration than the cladding portion, and a Ag concentration gradient is present from a boundary between the core portion and the cladding portion toward a region in the core portion where the Ag concentration is maximum.

The core portion is a region where a refractive index is equal to or greater than a value represented by {N+(Δn/2)}, where Δn is a refractive index difference represented by (Nmax−N), Nmax is a maximum value of a refractive index in the core portion, and N is a refractive index of the cladding portion.

The refractive index difference Δn is 0.005 or more. A core thickness Δd of the core portion in a thickness direction of the glass substrate is 2.5 μm to 10 μm.

Details of a method for producing the glass substrate according to the present embodiment is to be described later. The core portion to be an optical waveguide is formed by ion exchange of Na ions in a desired region of the glass substrate with Ag ions. Therefore, a composition of the glass in a portion of the cladding portion not influenced by the ion exchange is the same as a base composition of the glass substrate. The portion not influenced by the ion exchange is a portion sufficiently away from the core portion, and for example, when the portion is away from the boundary between the core portion and the cladding portion by 50 μm or more, it can be said that there is no influence of the ion exchange. The composition of the glass to be the core portion is the same as the base composition of the glass substrate in terms of components not involved in the ion exchange.

Therefore, since the Ag concentration in the core portion is higher than the Ag concentration in the cladding portion, the refractive index of the core portion is higher than the refractive index of the cladding portion, and the core portion functions as an optical waveguide.

As described above, since the core portion is formed by ion exchange, the Ag concentration in the core portion is not uniform, and a Ag concentration gradient is present from the boundary between the core portion and the cladding portion toward the region in the core portion where the Ag concentration is maximum. That is, the Ag concentration continuously changes from the cladding portion toward a center of the core portion. However, this does not exclude no change in the Ag concentration near the center of the core portion.

The core portion preferably has a substantially circular shape in a cross-sectional view perpendicular to a path of the optical waveguide. The “substantially circular shape” means a shape having an aspect ratio of 0.33 to 1.25, which is calculated based on a maximum width in a horizontal direction and a maximum height in a vertical direction in the same cross-sectional view. The aspect ratio is preferably 0.4 or more, more preferably 0.6 or more, and is preferably 1.2 or less, more preferably 1.0 or less, from the viewpoint of confining light. In the case where the aspect ratio is 1, it is a perfect circle.

In the case where the core portion has a substantially circular shape in the same cross-sectional view, the Ag concentration is high in a region close to a center of the substantially circular shape, and the Ag concentration decreases as the distance from the center increases.

The core portion may have a fan shape including a semicircular shape, and preferably a semicircular shape in the same cross-sectional view. The “fan shape” is formed by two radii and an arc between the radii, and a shape in which an arc portion is positioned on a lower side in the vertical direction in the same cross-sectional view is preferred.

In the case where the core portion has a fan shape in the same cross-sectional view, the Ag concentration is high in a region close to an intersection point of the two radii, and the Ag concentration decreases as the distance from the intersection point increases. In the case where the arc portion of the fan shape is positioned on the lower side in the vertical direction in the same cross-sectional view and the intersection point is positioned on the outermost surface of the glass substrate or at a position close thereto, the core portion functions as an optical waveguide by separately providing a layer having a low refractive index on an upper portion of the core portion. The layer having a low refractive index is not particularly limited, and the layer having a low refractive index functions as the cladding portion.

Examples of a method of forming the core portion in the related art include a method of forming a film of a component having a high refractive index on a part of a surface of a substrate by sputtering or the like and forming a film of a component having a low refractive index such as a component same as that of the substrate again. Examples also include a method of bonding different kinds of materials having different refractive indices.

When making a difference in concentration of the component exhibiting a high refractive index between the core portion and the cladding portion by using such a method of forming a core portion in the related art, a component concentration exhibiting a high refractive index at the boundary between the core portion and the cladding portion and a component concentration exhibiting a high refractive index in the core portion discontinuously change. In this regard, a form of a concentration change of Ag, which is a component exhibiting a high refractive index, from the cladding portion to the core portion in the present embodiment, and a form of a concentration change of a component exhibiting a high refractive index from the cladding portion to the core portion in the related art can be clearly distinguished from each other.

Since the core portion in the present embodiment is formed by ion exchange, the Ag concentration in the core portion is not constant, and there is a difference in refractive index. Similarly, in a region of the cladding portion near the boundary with the core portion, the Ag concentration is not constant, and there is also a difference in refractive index.

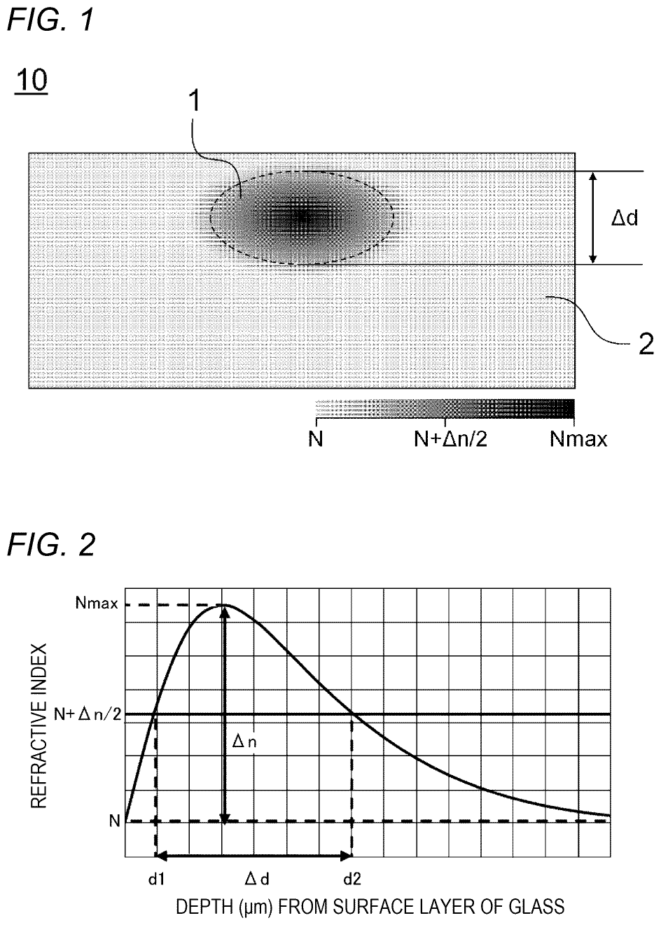

Therefore, in the present embodiment, the core portion is defined as follows. FIG. 1 is a schematic diagram illustrating the core portion and the cladding portion. FIG. 2 is a diagram illustrating a refractive index maximum value Nmax, a refractive index N, a refractive index difference Δn, and a core thickness Δd, and is a graph showing a relationship between a depth from the surface of the glass substrate and the refractive index in a region including the core portion in the glass substrate. Both FIGS. 1 and 2 do not relate to an actually obtained glass substrate.

The refractive index in the present description is a refractive index for light having a wavelength of 589 nm.

First, the maximum value of the refractive index is defined as Nmax in a cross-sectional view perpendicular to a path of an optical waveguide of core portion 1 in a glass substrate 10 as shown in FIG. 1. In FIG. 1, a magnitude of the refractive index is schematically shown by the shading of the color. The darker the color, the higher the refractive index, and the lighter the color, the lower the refractive index.

Here, a depth from a surface layer of the glass substrate 10 and the refractive index at each depth have a relationship as shown in the graph of FIG. 2. Since the refractive index of the core portion 1 to be an optical waveguide is higher than a refractive index of a cladding portion 2, the highest refractive index when the refractive index is measured in a depth direction from the surface of the glass substrate 10 may be set as the maximum value Nmax of the refractive index in the core portion 1.

Next, the refractive index of the cladding portion 2 is defined as N. As described above, since the core portion 2 is formed by ion exchange, the refractive index of the cladding portion 2 is also high in a region close to a boundary with the core portion 1 and is not constant. Therefore, as the refractive index N of the cladding portion 2, a refractive index of a glass having a composition same as a base composition of a glass before ion exchange, that is, a refractive index of a base glass is used. In the cladding portion 2 of the glass substrate 10 according to the present embodiment, the refractive index of the cladding portion 2 in a region sufficiently away from the core portion 1 is the same as the refractive index of the base composition. Therefore, for example, the refractive index of the glass at a thickness center of the glass substrate 10 may be set as the refractive index N of the cladding portion 2, although it depends on a thickness of the glass substrate 10.

The refractive index difference represented by the difference (Nmax−N) between the Nmax and the N as described above is defined as Δn, and a region where the refractive index is equal to or greater than a value represented by {N+(Δn/2)}, that is, a region surrounded by a dotted line in FIG. 1 is defined as the core portion 1.

A maximum value of the depth of the core portion 1 in a thickness direction where the refractive index is equal to or greater than {N+(Δn/2)} is defined as the core thickness Δd of the core portion 1 in the thickness direction of the glass substrate 10.

In the present embodiment, the refractive index difference Δn between the refractive index N of the cladding portion and the maximum value Nmax of the refractive index in the core portion is 0.005 or more, and the core thickness Δd where the refractive index is equal to or greater than {N+(Δn/2)} is 2.5 μm to 10 μm, so that the optical waveguide can cope with light propagated in a single mode.

The Δn is 0.005 or more, and the Δn is, for example, preferably 0.005 to 0.05, more preferably 0.007 to 0.04, and may be 0.009 to 0.03, 0.01 to 0.02, or 0.012 to 0.018. Here, the Δn is 0.005 or more, preferably 0.007 or more, and may be 0.009 or more, 0.01 or more, or 0.012 or more, from the viewpoint of controlling the incident light, for example, bending the incident light. The upper limit of the Δn is not particularly limited, and the refractive index difference that can be caused by ion exchange is usually 0.05 or less, preferably 0.04 or less, and may be 0.03 or less, 0.02 or less, or 0.018 or less.

In the present embodiment, the core thickness Δd of the core portion in the thickness direction of the glass substrate is 2.5 μm to 10 μm, preferably 3 μm to 9 μm, and may be 3.5 μm to 8 μm, 4 μm to 7 μm, 4.25 μm to 6 μm, or 4.5 μm to 5.5 μm. The core thickness Δd may be 3 μm to 8 μm, 3 μm to 7 μm, 3 μm to 6 μm, or 3 μm to 5.5 μm. Here, it is necessary to increase the refractive index difference between the core portion and the cladding portion as the core thickness decreases, but in this case, a mode field diameter changes with a slight change in refractive index, and it is difficult to strictly control the core thickness. In addition, in the case of a bent region as an optical waveguide, it is difficult to confine light. Therefore, the Δd is 2.5 μm or more, preferably 3 μm or more, and may be 3.5 μm or more, 4 μm or more, 4.25 μm or more, or 4.5 μm or more. In the case of a bent region in the path of the optical waveguide, the Δd is 10 μm or less, preferably 9 μm or less, and may be 8 μm or less, 7 μm or less, 6 μm or less, or 5.5 μm or less, from the viewpoint of preventing a bending loss.

The maximum value Nmax of the refractive index in the core portion is not particularly limited, and in view of the refractive index of the base composition of the glass substrate usually used for the optical waveguide, the Nmax is, for example, preferably 1.50 to 2.0, more preferably 1.51 to 1.9, still more preferably 1.52 to 1.8, even more preferably 1.525 to 1.7, and particularly preferably 1.53 to 1.6. Here, the Nmax is preferably 1.50 or more, more preferably 1.51 or more, still more preferably 1.52 or more, even more preferably 1.525 or more, and particularly preferably 1.53 or more, from the viewpoint of matching the refractive index with that of a silicon semiconductor and reducing a loss due to bonding. The Nmax is preferably 2.0 or less, more preferably 1.9 or less, still more preferably 1.8 or less, even more preferably 1.7 or less, and particularly preferably 1.6 or less, from the viewpoint of receiving light from an optical fiber such as SiO₂.

The refractive index N in the cladding portion is not particularly limited, and in view of the refractive index of the base composition of the glass substrate usually used for the optical waveguide, the N is, for example, preferably 1.50 to 1.59, more preferably 1.51 to 1.58, still more preferably 1.52 to 1.57, even more preferably 1.525 to 1.56, and particularly preferably 1.53 to 1.555. Here, the N is preferably 1.50 or more, more preferably 1.51 or more, still more preferably 1.52 or more, even more preferably 1.525 or more, and particularly preferably 1.53 or more, from the viewpoint of matching the refractive index with that of a silicon semiconductor and reducing a loss due to bonding. The N is preferably 1.59 or less, more preferably 1.58 or less, still more preferably 1.57 or less, even more preferably 1.56 or less, and particularly preferably 1.555 or less, from the viewpoint of receiving light from an optical fiber such as SiO₂.

The base composition of the glass substrate according to the present embodiment, that is, the composition of the glass of the cladding portion is not particularly limited as long as the core portion under desired conditions is formed by appropriate ion exchange of Na ions in the glass with Ag ions.

The desired conditions of the core portion are, for example, that the Δn is 0.005 or more and the Δd is 2.5 μm to 10 μm, as described above. In particular, in order to cope with light propagated in a single mode, it is required that there is a sufficient refractive index difference between the core portion and the cladding portion and that an ion exchange depth of the Ag ions after the ion exchange can be controlled.

Among the above, in order to provide a sufficient refractive index difference between the core portion and the cladding portion, that is, to set the refractive index difference Δn to 0.005 or more, it is important to contain a sufficient amount of Na in the glass.

Among the above, in order to stably form the core portion in which the ion exchange depth is controlled, it has been found that it is important that an ion exchange rate from Na ions to Ag ions is not too fast. As a result of studies by the inventors of the present invention, when forming a core portion by directly employing ion exchange that has been performed for the purpose of improving a glass strength in the related art, the ion exchange rate is too fast, and it is difficult to control the ion exchange depth. As a result, the core thickness Δd is more than 10 μm, and it is difficult to cope with the light propagated in a single mode. In addition, in order to obtain an ion exchange depth such that the core thickness Δd of 10 μm or less, it is necessary to shorten the time for bringing the glass into contact with the molten salt, but as a result, the glass is heated unevenly, and homogeneity of the core portion decreases.

With respect to this, it has been found that the ion exchange depth can be appropriately controlled and the homogeneity of the core portion can be maintained when the ion exchange rate is such that the core thickness Δd can be 2.5 μm to 10 μm by an ion exchange treatment for 20 minutes or longer, for example. From the viewpoint of productivity, the time of the ion exchange treatment is preferably 6 hours or shorter.

It has been found that it is preferable to reduce a content of an Al component as the base composition of the glass substrate, that is, the composition of the glass of the cladding portion, in order to appropriately perform ion exchange from Na ions to Ag ions in the treatment time as described above. It has also been found that when a content of an alkaline earth metal component is added, the ion exchange rate from Na ions to Ag ions increases, but when the content is set to a certain amount or more, the ion exchange rate conversely decreases.

Therefore, in the case where the base composition of the glass substrate according to the present embodiment, that is, the glass of the cladding portion is a silicate glass, a content of Al₂O₃ is preferably 0% to 15% and a total content of MgO, CaO, SrO, and BaO is preferably 10% to 30% in mol % in terms of oxides.

That is, the glass of the cladding portion in the present embodiment preferably satisfies the following contents in mol % in terms of oxides: 45% to 80% of SiO₂ and 0% to 15% of Al₂O₃. It is also preferably to satisfy 45% to 80% of SiO₂ and 10% to 30% of MgO, CaO, SrO, and BaO in total, and it is more preferably to satisfy 45% to 80% of SiO₂, 0% to 15% of Al₂O₃, and 10% to 30% of MgO, CaO, SrO, and BaO in total. It is more preferable to further satisfy 4.5% to 25% of Na₂O.

More specifically, the glass of the cladding portion in the present embodiment still more preferably satisfies the following contents in mol % in terms of oxides.
45% to 80% of SiO₂,
0% to 15% of Al₂O₃,
0% to 20% of B₂O₃,
10% to 30% of MgO, CaO, SrO, and BaO in total, and
4.5% to 25% of Na₂O.

Each component constituting the glass of the cladding portion is described below.

The content of SiO₂ is preferably 40% to 80%, more preferably 45% to 80%, still more preferably 45% to 75%, even more preferably 50% to 70%, even still more preferably 52.5% to 67.5%, and particularly preferably 55% to 65%. The content of SiO₂ is preferably 40% or more, more preferably 45% or more, still more preferably 50% or more, even more preferably 52.5% or more, and particularly preferably 55% or more, from the viewpoint of forming a glass network and improving chemical durability. The content of SiO₂ is preferably 80% or less, more preferably 75% or less, still more preferably 70% or less, even more preferably 67.5% or less, and particularly preferably 65% or less, from the viewpoint of meltability.

The content of Al₂O₃ is preferably 0% to 15%, more preferably 1% to 12.5%, still more preferably 1.5% to 10%, even more preferably 2% to 8%, and particularly preferably 2.5% to 7.5%. Al₂O₃ does not need to be contained, but from the viewpoint of increasing the ion exchange rate and improving the productivity, the content of Al₂O₃ is preferably 1% or more, more preferably 1.5% or more, still more preferably 2% or more, and even more preferably 2.5% or more. The content of Al₂O₃ is preferably 15% or less, more preferably 12.5% or less, still more preferably 10% or less, even more preferably 8% or less, and particularly preferably 7.5% or less, from the viewpoint of reducing the ion exchange rate from Na ions in the glass to Ag ions, realizing the desired core thickness Δd, and forming a core portion having high homogeneity.

The content of B₂O₃ is preferably 0% to 20%, more preferably 2% to 17.5%, still more preferably 4% to 15%, even more preferably 6% to 12.5%, and particularly preferably 8% to 11%. B₂O₃ does not need to be contained, but from the viewpoint of improving the meltability, the content of B₂O₃ is preferably 2% or more, more preferably 4% or more, still more preferably 6% or more, and even more preferably 8% or more. On the other hand, the content of B₂O₃ is preferably 20% or less, more preferably 17.5% or less, still more preferably 15% or less, even more preferably 12.5% or less, and particularly preferably 11% or less, from the viewpoint of preventing occurrence of striae during melting and deterioration of the quality of the glass substrate. In order to improve acid resistance, it is preferable not to contain B₂O₃.

The total content of the alkaline earth metal oxides represented by the total of MgO, CaO, SrO, and BaO is preferably 10% to 30%, more preferably 11% to 27.5%, still more preferably 12% to 25%, even more preferably 13% to 22.5%, and particularly preferably 14% to 20%. The total content is preferably 10% or more, more preferably 11% or more, still more preferably 12% or more, even more preferably 13% or more, and particularly preferably 14% or more, from the viewpoint of reducing the ion exchange rate from Na ions in the glass to Ag ions, realizing the desired core thickness Δd, and forming a core portion having high homogeneity. The total content is preferably 30% or less, more preferably 27.5% or less, still more preferably 25% or less, even more preferably 22.5% or less, and particularly preferably 20% or less, from the viewpoint of improving the productivity of producing a waveguide by increasing the ion exchange rate to some extent.

The content of MgO is preferably 0% to 20%, more preferably 1% to 18%, still more preferably 2% to 16%, even more preferably 3% to 14%, and particularly preferably 4% to 12%. MgO does not need to be contained, but from the viewpoint of improving the meltability of the glass and controlling the ion exchange rate, the content of MgO is preferably 1% or more, more preferably 2% or more, still more preferably 3% or more, and particularly preferably 4% or more. The content of MgO is preferably 20% or less, more preferably 18% or less, still more preferably 16% or less, even more preferably 14% or less, and particularly preferably 12% or less, from the viewpoint of preventing devitrification during melting.

The content of CaO is preferably 0% to 20%, more preferably 1% to 18%, still more preferably 2% to 16%, even more preferably 3% to 14%, even still more preferably 4% to 12%, and particularly preferably 4.5% to 12%. CaO does not need to be contained, but from the viewpoint of improving the meltability of the glass and controlling the ion exchange rate, the content of CaO is preferably 1% or more, more preferably 2% or more, still more preferably 3% or more, even still more preferably 4% or more, and particularly preferably 4.5% or more. The content of CaO is preferably 20% or less, more preferably 18% or less, still more preferably 16% or less, even more preferably 14% or less, and particularly preferably 12% or less, from the viewpoint of preventing devitrification during melting.

The content of SrO is preferably 0% to 20%, more preferably 1% to 18%, still more preferably 2% to 16%, even more preferably 3% to 14%, even still more preferably 4% to 12%, and particularly preferably 4.5% to 12%. SrO does not need to be contained, but from the viewpoint of improving the meltability of the glass and controlling the ion exchange rate, the content of SrO is preferably 1% or more, more preferably 2% or more, still more preferably 3% or more, even still more preferably 4% or more, and particularly preferably 4.5% or more. The content of SrO is preferably 20% or less, more preferably 18% or less, still more preferably 16% or less, even more preferably 14% or less, and particularly preferably 12% or less, from the viewpoint of preventing devitrification during melting.

The content of BaO is preferably 0% to 20%, more preferably 1% to 18%, still more preferably 2% to 16%, even more preferably 3% to 14%, even still more preferably 4% to 12%, and particularly preferably 4.5% to 12%. BaO does not need to be contained, but from the viewpoint of improving the meltability of the glass and controlling the ion exchange rate, the content of BaO is preferably 1% or more, more preferably 2% or more, still more preferably 3% or more, even still more preferably 4% or more, and particularly preferably 4.5% or more. The content of BaO is preferably 20% or less, more preferably 18% or less, still more preferably 16% or less, even more preferably 14% or less, and particularly preferably 12% or less, from the viewpoint of preventing devitrification during melting.

The content of Al₂O₃ and the total content of alkaline earth metal oxides represented by the total of MgO, CaO, SrO, and BaO are both components that reduce the ion exchange rate from Na ions in the glass to Ag ions. As described above, it is preferable to set the core thickness Δd of the core portion to 2.5 μm to 10 μm by the ion exchange treatment for about 20 minutes to 6 hours, but as a result of advancing the study on the composition of the glass of the cladding portion, it has been found that specific relational expressions using the contents of the components described above each have a good correlation with the ion exchange rate.

One of the above relational expressions is an expression (1) represented by (MgO+CaO+SrO×2+BaO×2−Al₂O₃×2), using the contents in mol % in terms of oxides.

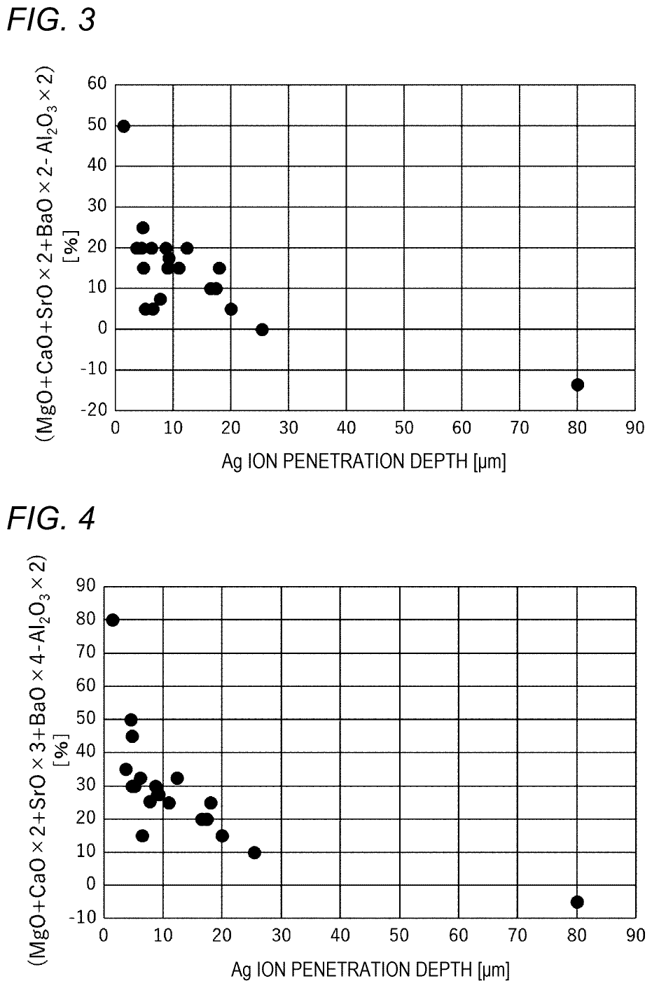

FIG. 3 shows a relationship between a value represented by the expression (1): (MgO+CaO+SrO×2+BaO×2−Al₂O₃×2) in the glass composition of the cladding portion in an actually obtained glass substrate and a Ag ion penetration depth after an ion exchange treatment is performed. The ion exchange treatment is performed by using a mixed molten salt of NaNO₃:AgNO₃=99:1 (mass ratio) and immersing the glass substrate in the mixed molten salt at 400° C. for 1 hour. The Ag ion penetration depth used in FIG. 3 is a depth from the glass surface at which the refractive index coincides with the refractive index of the glass before the ion exchange treatment when a refractive index distribution from the glass surface is measured using an optical waveguide surface stress meter manufactured by Orihara Industrial Co., Ltd.

As seen from FIG. 3, there is a correlation between the value represented by the expression (1) and the Ag ion penetration depth. That is, there is a correlation between the value represented by the expression (1) and ease of ion exchange from Na ions to Ag ions.

The value represented by the expression (1) is preferably 0% to 30%, more preferably 2.5% to 27.5%, still more preferably 5% to 25%, even more preferably 7.5% to 22.5%, and particularly preferably 10% to 20%. Here, the value represented by the expression (1) is preferably 0% or more, more preferably 2.5% or more, still more preferably 5% or more, even more preferably 7.5% or more, and particularly preferably 10% or more, from the viewpoint of the controllability for the core thickness Δd of the core portion. The value represented by the expression (1) is preferably 30% or less, more preferably 27.5% or less, still more preferably 25% or less, even more preferably 22.5% or less, and particularly preferably 20% or less, from the viewpoint of the productivity.

One of the above relational expressions is an expression (2) represented by (MgO+CaO×2+SrO×3+BaO×4−Al₂O₃×2), using the contents in mol % in terms of oxides.

FIG. 4 shows a relationship between a value represented by the expression (2): (MgO+CaO×2+SrO×3+BaO×4−Al₂O₃×2) in the glass composition of the cladding portion in the actually obtained glass substrate and the Ag ion penetration depth after an ion exchange treatment is performed. The ion exchange treatment and the method for measuring the Ag ion penetration depth are the same as the ion exchange treatment and the method for measuring the Ag ion penetration depth used in the study on the above expression (1).

As seen from FIG. 4, there is a correlation between the value represented by the expression (2) and the Ag ion penetration depth. That is, there is a correlation between the value represented by the expression (2) and the ease of ion exchange from Na ions to Ag ions.

The value represented by the expression (2) is preferably 0% to 60%, more preferably 5% to 55%, still more preferably 10% to 50%, even more preferably 15% to 45%, and particularly preferably 20% to 40%. Here, the value represented by the expression (2) is preferably 0% or more, more preferably 5% or more, still more preferably 10% or more, even more preferably 15% or more, and particularly preferably 20% or more, from the viewpoint of the controllability for the core thickness Δd of the core portion. The value represented by the expression (2) is preferably 60% or less, more preferably 55% or less, still more preferably 50% or less, even more preferably 45% or less, and particularly preferably 40% or less, from the viewpoint of the productivity.

The content of Na₂O is preferably 4.5% to 25%, more preferably 6% to 22.5%, still more preferably 7% to 20%, even more preferably 8% to 17.5%, and particularly preferably 9% to 16%. Na₂O is a component that imparts a high refractive index for the core portion to be an optical waveguide by ion exchange with Ag ions, and improves the meltability of the glass. From the above viewpoints, the content of Na₂O is preferably 4.5% or more, more preferably 6% or more, still more preferably 7% or more, even more preferably 8% or more, and particularly preferably 9% or more. On the other hand, the content of Na₂O is preferably 25% or less, more preferably 22.5% or less, still more preferably 20% or less, even more preferably 17.5% or less, and particularly preferably 16% or less, from the viewpoint of improving water resistance of the glass.

Regarding the glass composition of the cladding portion, it has been found that, in addition to the above expression (1) and expression (2), the content of Na₂O and the total content of alkaline earth metal oxides represented by the total of MgO, CaO, SrO, and BaO also have a good correlation with the ion exchange rate.

Specific examples thereof include an expression (3) represented by {Na₂O/(MgO+CaO×2+SrO×3+BaO×4)}, using the content in mol % in terms of oxides.

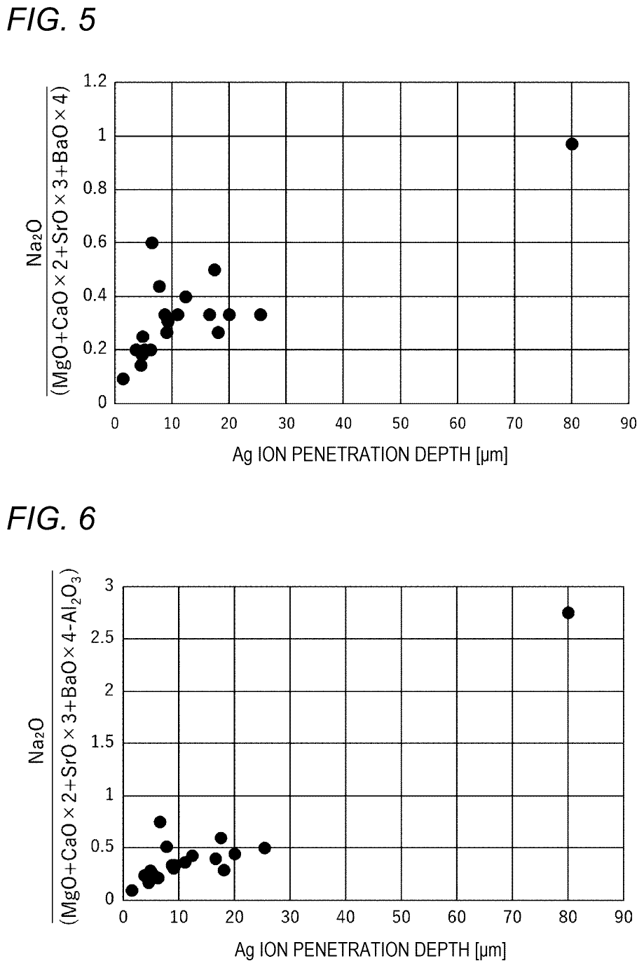

FIG. 5 shows a relationship between a value represented by the expression (3): {Na₂O/(MgO+CaO×2+SrO×3+BaO×4)} in the glass composition of the cladding portion in the actually obtained glass substrate and the Ag ion penetration depth after an ion exchange treatment is performed. The ion exchange treatment and the method for measuring the Ag ion penetration depth are the same as the ion exchange treatment and the method for measuring the Ag ion penetration depth used in the study on the above expression (1).

As seen from FIG. 5, there is a correlation between the value represented by the expression (3) and the Ag ion penetration depth. That is, there is a correlation between the value represented by the expression (3) and the ease of ion exchange from Na ions to Ag ions.

The value represented by the expression (3) is preferably 0.1 to 0.7, more preferably 0.125 to 0.6, still more preferably 0.15 to 0.5, even more preferably 0.175 to 0.45, and particularly preferably 0.2 to 0.4. Here, the value represented by the expression (3) is preferably 0.1 or more, more preferably 0.125 or more, still more preferably 0.15 or more, even more preferably 0.175 or more, and particularly preferably 0.2 or more, from the viewpoint of the productivity. The value represented by the expression (3) is preferably 0.7 or less, more preferably 0.6 or less, still more preferably 0.5 or less, even more preferably 0.45 or less, and particularly preferably 0.4 or less, from the viewpoint of the controllability for the core thickness Δd of the core portion.

Regarding the glass composition of the cladding portion, it has been found that, in addition to the content of Na₂O and the total content of alkaline earth metal oxides represented by the total of MgO, CaO, SrO, and BaO, the content of Al₂SO₃ also has a good correlation with the ion exchange rate.

Specific examples thereof include an expression (4) represented by {Na₂O/(MgO+CaO×2+SrO×3+BaO×4−Al₂O₃)}, using the content in mol % in terms of oxides.

FIG. 6 shows a relationship between a value represented by the expression (4): {Na₂O/(MgO+CaO×2+SrO×3+BaO×4−Al₂O₃)} in the glass composition of the cladding portion in the actually obtained glass substrate and the Ag ion penetration depth after an ion exchange treatment is performed. The ion exchange treatment and the method for measuring the Ag ion penetration depth are the same as the ion exchange treatment and the method for measuring the Ag ion penetration depth used in the study on the above expression (1).

As seen from FIG. 6, there is a correlation between the value represented by the expression (4) and the Ag ion penetration depth. That is, there is a correlation between the value represented by the expression (4) and the ease of ion exchange from Na ions to Ag ions.

The value represented by the expression (4) is preferably 0.1 to 2, more preferably 0.125 to 1.5, still more preferably 0.15 to 1, even more preferably 0.175 to 0.8, and particularly preferably 0.2 to 0.5. Here, the value represented by the expression (4) is preferably 0.1 or more, more preferably 0.125 or more, still more preferably 0.15 or more, even more preferably 0.175 or more, and particularly preferably 0.2 or more, from the viewpoint of the productivity. The value represented by the expression (4) is preferably 2 or less, more preferably 1.5 or less, still more preferably 1 or less, even more preferably 0.8 or less, and particularly preferably 0.5 or less, from the viewpoint of the controllability for the core thickness Δd of the core portion.

The content of Li₂O is preferably 0% to 10%, more preferably 0.1% to 5%, still more preferably 0.3% to 4%, even more preferably 0.4% to 3%, and particularly preferably 0.5% to 2.5%. Li₂O does not need to be contained, but from the viewpoint of improving the meltability, the content of Li₂O is preferably 0.1% or more, more preferably 0.3% or more, still more preferably 0.4% or more, and particularly preferably 0.5% or more. On the other hand, the content of Li₂O is preferably 10% or less, more preferably 5% or less, still more preferably 4% or less, even more preferably 3% or less, and particularly preferably 2.5% or less, from the viewpoint of increasing the Δn.

The content of K₂O is preferably 0% to 10%, more preferably 0.1% to 5%, still more preferably 0.3% to 4%, even more preferably 0.4% to 3%, and particularly preferably 0.5% to 2.5%. K₂O does not need to be contained, but from the viewpoint of improving the meltability, the content of K₂O is preferably 0.1% or more, more preferably 0.3% or more, still more preferably 0.4% or more, and still more preferably 0.5% or more. On the other hand, the content of K₂O is preferably 10% or less, more preferably 5% or less, still more preferably 4% or less, even more preferably 3% or less, and particularly preferably 2.5% or less, from the viewpoint of preventing a reduction in Δn.

The content of P₂O₅ is preferably 0% to 4%, more preferably 0.5% to 3%, and still more preferably 1% to 2%. P₂O₅ does not need to be contained, but from the viewpoint of ion exchange performance and chipping resistance, the content of P₂O₅ is preferably 0.5% or more, more preferably 1% or more, and still more preferably 2% or more,. On the other hand, the content of P₂O₅ is preferably 4% or less, more preferably 3% or less, still more preferably 2% or less, and still more preferably 1% or less, from the viewpoint of crushability and the acid resistance. From the viewpoint of the acid resistance, it is preferable that P₂O₅ is substantially not contained.

Note that, “substantially not contained” in the present description means that a component is not contained other than inevitable impurities contained in a raw material or the like, that is, the component is not intentionally contained. Specifically, it means that the content in the glass composition is less than 0.1 mol %.

The content of ZnO is preferably 0% to 10%, more preferably 0.25% to 7%, still more preferably 0.25% to 5%, even more preferably 0.5% to 2%, and particularly preferably 0.5% to 1%. ZnO does not need to be contained, but from the viewpoint of the meltability, the content of ZnO is preferably 0.25% or more, and more preferably 0.5% or more. On the other hand, the content of ZnO is preferably 10% or less, more preferably 7% or less, still more preferably 5% or less, even more preferably 2% or less, and particularly preferably 1% or less, from the viewpoint of weather resistance.

The content of TiO₂ is preferably 0% to 1%, more preferably 0.1% to 0.5%, still more preferably 0.15% to 0.5%, and even more preferably 0.2% to 0.25%. TiO₂ does not need to be contained, but from the viewpoint of the crushability, the content of TiO₂ is preferably 0.1% or more, more preferably 0.15% or more, and still more preferably 0.2% or more. On the other hand, the content of TiO₂ is preferably 1% or less, more preferably 0.5% or less, and still more preferably 0.25% or less, from the viewpoint of preventing the deterioration of the quality due to devitrification.

The content of ZrO₂ is preferably 0% to 8%, more preferably 0.5% to 6%, still more preferably 0.5% to 4%, even more preferably 1% to 2%, and particularly preferably 1% to 1.2%. ZrO₂ does not need to be contained, but from the viewpoint of improving the weather resistance, the content of ZrO₂ is preferably 0.5% or more, and more preferably 1% or more. On the other hand, the content of ZrO₂ is preferably 8% or less, more preferably 6% or less, still more preferably 4% or less, even more preferably 2% or less, and particularly preferably 1.2% or less, from the viewpoint of preventing the deterioration of the quality due to devitrification.

The content of each of Y₂O₃, La₂O₃, and Nb₂O₅ is preferably 0% to 8%, more preferably 0.5% to 6%, still more preferably 1% to 5%, even more preferably 1.5% to 4%, even still more preferably 2% to 3%, and particularly preferably 2.5% to 3%. Y₂O₃, La₂O₃, and Nb₂O₅ do not need to be contained, but from the viewpoint of improving the weather resistance, the content of each of Y₂O₃, La₂O₃, and Nb₂O₅ is preferably 0.5% or more, more preferably 1% or more, still more preferably 1.5% or more, even more preferably 2% or more, and particularly preferably 2.5% or more. On the other hand, the content of each of Y₂O₃, La₂O₃, and Nb₂O₅ is preferably 8% or less, more preferably 6% or less, still more preferably 5% or less, even more preferably 4% or less, and particularly preferably 3% or less, from the viewpoint of preventing the deterioration of the quality due to devitrification.

The content of each of Ta₂O₅ and Gd₂O₃ is preferably 0% to 1%, and more preferably 0% to 0.5%. Ta₂O₅ and Gd₂O₃ do not need to be contained, but may be contained in a small amount from the viewpoint of improving the weather resistance. On the other hand, the content of each of Ta₂O₅ and Gd₂O₃ is preferably 1% or less, more preferably 0.5% or less, and still more preferably Ta₂O₅ and Gd₂O₃ are substantially not contained, from the viewpoint of the refractive index and a reflectance.

In the case of coloring the glass for use, a coloring component may be added within a range that does not inhibit the desired effect. Examples of the coloring component include Co₃O₄, MnO₂, Fe₂O₃, NiO, CuO, Cr₂O₃, V₂O₅, Bi₂O₃, SeO₂, TiO₂, CeO₂, Er₂O₃, and Nd₂O₃.

The total content of the coloring component is preferably 0% to 7%, more preferably 0% to 5%, still more preferably 0% to 3%, and even more preferably 0% to 1%. The total content of the coloring component is preferably 7% or less, more preferably 5% or less, still more preferably 3% or less, even more preferably 1% or less, and particularly preferably the coloring component is substantially not contained, from the viewpoint of preventing the devitrification.

SO₃, a chloride, and a fluoride may be appropriately contained as a refining agent during melting of the glass.

As₂O₃ is preferably substantially not contained. In the case where Sb₂O₃ is contained, the content thereof is preferably 0.3% or less, more preferably 0.1% or less, and still more preferably Sb₂O₃ is substantially not contained.

Ag₂O may be contained from the viewpoint of improving ion exchangeability, but since Ag₂O is a component used for increasing the refractive index of the core portion, even in the case of containing Ag₂O, the content thereof is preferably less than 0.01%, more preferably 0.005% or less, and still more preferably 0.001% or less. From the viewpoint of increasing the refractive index of the core portion, it is more preferable that Ag₂O is substantially not contained. Note that, “Ag₂O is substantially not contained” means less than a detection limit value of a device.

A glass of the core portion of the glass substrate according to the present embodiment is formed by ion exchange of Na ions with Ag ions in a region desired to be an optical waveguide with respect to the glass substrate. Therefore, the contents of components other than Na₂O and Ag₂O are common to those in the base composition of the glass substrate, that is, the composition of the glass of the cladding portion.

Similar to the glass of the cladding portion, in the case where the glass of the core portion in the present embodiment is a silicate glass, the content of Al₂O₃ is preferably 0% to 15% and the total content of MgO, CaO, SrO, and BaO is preferably 10% to 30% in mol % in terms of oxides. The content of Na₂O is preferably 4% to 20%, and the content of Ag₂O is preferably 0.01% or more.

That is, the glass of the core portion in the present embodiment preferably satisfies the following contents in mol % in terms of oxides: 45% to 80% of SiO₂, 0% to 15% of Al₂O₃, 0% to 20% of Na₂O, and 0.01% or more of Ag₂O. It is also preferably to satisfy 45% to 80% of SiO₂, 10% to 30% of MgO, CaO, SrO, and BaO in total, 0% to 20% of Na₂O, and 0.01% or more of Ag₂O, and it is more preferably to satisfy 45% to 80% of SiO₂, 0% to 15% of Al₂O₃, 10% to 30% of MgO, CaO, SrO, and BaO in total, 0% to 20% of Na₂O, and 0.01% or more of Ag₂O.

More specifically, the glass of the core portion in the present embodiment still more preferably satisfies the following contents in mol % in terms of oxides.
45% to 80% of SiO₂,
0% to 15% of Al₂O₃,
0% to 20% of B₂O₃,
10% to 30% of MgO, CaO, SrO, and BaO in total,
0% to 20% of Na₂O, and
0.01% or more of Ag₂O.

With respect to each component constituting the glass of the core portion, the suitable content of the component other than Na₂O and Ag₂O and the reason therefor are the same as those of each component constituting the glass of the cladding portion.

The content of Na₂O in the glass of the core portion is lower than the content of Na₂O in the glass of the cladding portion, and varies depending on the content of Na₂O in the cladding portion, and thus cannot be unconditionally defined. It is, for example, preferably 0% to 20%, more preferably 1% to 17.5%, still more preferably 2% to 15%, even more preferably 3% to 12.5%, and particularly preferably 4% to 10%. The content of Na₂O in the core portion is preferably 0% or more, more preferably 1% or more, still more preferably 2% or more, even more preferably 3% or more, and particularly preferably 4% or more, from the viewpoint of the meltability of the glass. On the other hand, the content of Na₂O is preferably 20% or less, more preferably 17.5% or less, still more preferably 15% or less, even more preferably 12.5% or less, and particularly preferably 10% or less, from the viewpoint of preventing the Δn from being too high and preventing loss of propagation in a single mode.

A difference in content of Na₂O between the glass of the core portion and the glass of the cladding portion has a relationship with an ion exchange amount between Na ions and Ag ions, and is preferably 1% to 15%, more preferably 1.5% to 14%, still more preferably 2% to 13%, even more preferably 2.5% to 12%, and particularly preferably 3% to 11%. The difference in content of Na₂O is preferably 1% or more, more preferably 1.5% or more, still more preferably 2% or more, even more preferably 2.5% or more, and particularly preferably 3% or more, from the viewpoint of increasing the refractive index of the core portion by ion exchange with Ag ions and more suitably coping with the light propagated in a single mode as an optical waveguide even in the case where the core thickness Δd is small. On the other hand, the difference in content of Na₂O is preferably 15% or less, more preferably 14% or less, still more preferably 13% or less, even more preferably 12% or less, and particularly preferably 11% or less, from the viewpoint of preventing a core diameter required for the light propagation in a single mode from being extremely narrow due to the refractive index difference between the core and the cladding being too large.

The content of Ag₂O in the glass of the core portion is, for example, preferably 0.01% or more, more preferably 0.01% to 10%, still more preferably 0.5% to 8%, even more preferably 1% to 6%, and particularly preferably 1.5% to 5%. The content of Ag₂O in the core portion is preferably 0.01% or more, more preferably 0.5% or more, still more preferably 1% or more, and even more preferably 1.5% or more, from the viewpoint of increasing the refractive index of the core portion. On the other hand, the content of Ag₂O is preferably 10% or less, more preferably 8% or less, still more preferably 6% or less, and particularly preferably 5% or less, from the viewpoint that the core diameter must be reduced when the refractive index difference is too large.

The thickness of the glass substrate according to the present embodiment varies depending on a device on which the glass substrate is to be mounted, and is, for example, preferably 0.1 mm to 2.0 mm (100 μm to 2000 μm), more preferably 0.15 mm to 1.5 mm, still more preferably 0.2 mm to 1.25 mm, even more preferably 0.25 mm to 1.0 mm, and particularly preferably 0.3 mm to 0.8 mm. Here, the thickness of the glass substrate according to the present embodiment is preferably 0.1 mm or more, more preferably 0.15 mm or more, still more preferably 0.2 mm or more, even more preferably 0.25 mm or more, and particularly preferably 0.3 mm or more, from the viewpoint of ease of handling of members. On the other hand, the thickness of the glass substrate is preferably 2.0 mm or less, more preferably 1.5 mm or less, still more preferably 1.25 mm or less, even more preferably 1.0 mm or less, and particularly preferably 0.8 mm or less, from the viewpoint of reducing a height of electronic members.

A propagation loss amount of light having a wavelength of 1200 nm to 1600 nm in the core portion in the present embodiment is preferably 5.0 dB/cm or less, more preferably 4.0 dB/cm or less, still more preferably 3.0 dB/cm or less, even more preferably 2.0 dB/cm or less, and particularly preferably 1.5 dB/cm or less at maximum. The lower limit is not particularly limited since the propagation loss amount of the light is preferably as small as possible, and is usually 0.001 dB/cm or more.

The glass substrate according to the present embodiment can be mounted on, for example, an optical integrated device. In one embodiment of the optical integrated device, a glass substrate and a semiconductor substrate are connected to each other, and light propagated in a single mode is introduced into the semiconductor substrate via a core portion of the glass substrate. The semiconductor substrate is preferably, for example, a silicon semiconductor substrate.

The glass substrate according to the present embodiment is not limited to the above form, and may be mounted on a pluggable device.

The glass substrate according to the present embodiment can be applied not only to an optical transmission line as described above but also to a position such as an interposer.

### Method for Producing Glass Substrate

A method for producing a glass substrate according to the present embodiment is not particularly limited as long as the glass substrate described in the above <Glass Substrate> can be obtained, and includes, for example, the following steps.

(i) a step of preparing a glass sheet containing Na₂O, and

(ii) a step of bringing a region of the glass sheet to be an optical waveguide into contact with a molten salt containing Ag ions to perform ion exchange of Na ions in the glass with the Ag ions.

In the step (i), a glass may be produced or a commercially available glass may be used as it is.

In the case of producing a glass, a known method can be used. For example, raw materials of components of the glass are blended, and then heated and melted in a glass melting furnace. Thereafter, the glass is homogenized by a known method and molded into a desired shape, followed by annealing, to thereby obtain a glass sheet.

Examples of a method of molding a glass include a float process, a press method, a fusion method, and a down-draw method. Particularly, a float process suitable for mass production is preferred. As a continuous molding method other than the float process, that is, a fusion method and a down-draw method are also preferred.

Thereafter, the molded glass is ground and polished as necessary to form a glass sheet.

As one form of the ion exchange step in the step (ii), in the case of performing the ion exchange by immersing the glass sheet in a molten salt, it is preferable to mask a portion other than the region to be an optical waveguide.

The masking may be any masking as long as it does not react with the molten salt or does not inhibit ion exchange between a component constituting the glass and a component of the molten salt even in contact with the molten salt. For example, the masking is performed using Al₂O₃, SiO₂, SiN, TiO₂, ITO, or the like.

The masking may be appropriately adjusted according to the core thickness Δd of the core portion to be an optical waveguide and the maximum width in the horizontal direction in a cross-sectional view perpendicular to the path of the optical waveguide, and for example, a width of a gap for forming the core portion is preferably 4 μm to 12 μm, more preferably 5 μm to 11 μm, and still more preferably 6 μm to 10 μm. The width is preferably 4 μm or more, more preferably 5 μm or more, and still more preferably 6 μm or more, from the viewpoint of improving the effect of confining light. On the other hand, the width is preferably 12 μm or less, more preferably 11 μm or less, and still more preferably 10 μm or less, from the viewpoint of transmitting light in a single mode.

The method of bringing the masked glass sheet into contact with the molten salt containing Ag ions is not particularly limited, and examples thereof include immersion of a glass sheet in a molten salt, application of a molten salt, and spraying of a molten salt. Among them, immersion in a molten salt is preferred from the viewpoint of allowing a treatment at a high temperature for a long time.

The molten salt is any as long as it contains Ag ions, and examples of a salt containing Ag ions include AgNO₃, Ag₂SO₄, Ag₂CO₃, and AgCl. Among them, AgNO₃ is preferred from the viewpoint of a melting temperature. The salt containing Ag ions may be used alone or in combination of two or more kinds thereof.

In order to adjust the concentration of Ag ions in the molten salt, it is preferable to use a mixed molten salt obtained by mixing the salt containing Ag ions with another salt.

Examples of other salts include a nitrate, a sulfate, a carbonate, and a chloride. Among them, examples of the nitrate include lithium nitrate, sodium nitrate, potassium nitrate, and cesium nitrate. Examples of the sulfate include lithium sulfate, sodium sulfate, potassium sulfate, and cesium sulfate. Examples of the carbonate include lithium carbonate, sodium carbonate, and potassium carbonate. Examples of the chloride include lithium chloride, sodium chloride, potassium chloride, and cesium chloride.

Among them, sodium nitrate, sodium sulfate, sodium carbonate, and sodium chloride are preferably contained, and sodium nitrate and sodium sulfate are more preferred, from the viewpoint of preventing an unnecessary stress from being applied to the glass.

The above salts may be used alone or in combination of plural kinds thereof.

The content of the Ag ions with respect to the total amount of cations in the molten salt is preferably 0.5% to 20%, more preferably 1.0% to 19%, still more preferably 1.5% to 18%, even more preferably 2.0% to 17%, and particularly preferably 2.5% to 16% in terms of mass ratio. The content of the Ag ions is preferably 0.5% or more, more preferably 1.0% or more, still more preferably 1.5% or more, even more preferably 2.0% or more, and particularly preferably 2.5% or more, from the viewpoint of increasing the refractive index difference. On the other hand, the content of the Ag ions is preferably 20% or less, more preferably 19% or less, still more preferably 18% or less, even more preferably 17% or less, and particularly preferably 16% or less, from the viewpoint that control of the core diameter becomes too delicate when the refractive index is too large.

The content of the Ag ions with respect to the total amount of cations in the molten salt is preferably 0.1% to 20%, more preferably 0.5% to 17.5%, still more preferably 1.0% to 15%, even more preferably 2.0% to 12.5%, and particularly preferably 2.5% to 11% in cation %. The content of the Ag ions is preferably 0.1% or more, more preferably 0.5% or more, still more preferably 1.0% or more, even more preferably 2.0% or more, and particularly preferably 2.5% or more, from the viewpoint of increasing the refractive index difference. On the other hand, the content of the Ag ions is preferably 20% or less, more preferably 17.5% or less, still more preferably 15% or less, even more preferably 12.5% or less, and particularly preferably 11% or less, from the viewpoint that control of the core diameter becomes too delicate when the refractive index is too large.

The temperature of the molten salt is not particularly limited as long as it is equal to or higher than the melting point of the salt, and is, for example, preferably 350° C. to 490° C., more preferably 360° C. to 480° C., still more preferably 370° C. to 470° C., even more preferably 375° C. to 460° C., and particularly preferably 380° C. to 450° C. The temperature of the molten salt is preferably 350° C. or higher, more preferably 360° C. or higher, still more preferably 370° C. or higher, even more preferably 375° C. or higher, and particularly preferably 380° C. or higher, from the viewpoint of the productivity. On the other hand, the temperature of the molten salt is preferably 490° C. or lower, more preferably 480° C. or lower, still more preferably 470° C. or lower, even more preferably 460° C. or lower, and particularly preferably 450° C. or lower, from the viewpoint of having higher homogeneity and realizing the desired core thickness Δd.

The time of contact with the molten salt varies depending on the contact method, and the immersion time in the case of immersing the glass sheet in the molten salt is preferably 20 minutes to 6 hours, more preferably 30 minutes to 4 hours, still more preferably 35 minutes to 3 hours, even more preferably 40 minutes to 2.5 hours, and particularly preferably 45 minutes to 2 hours. Here, the immersion time is preferably 20 minutes or longer, more preferably 30 minutes or longer, still more preferably 35 minutes or longer, even more preferably 40 minutes or longer, and particularly preferably 45 minutes or longer, from the viewpoint of having higher homogeneity and realizing the desired core thickness Δd. On the other hand, the immersion time is preferably 6 hours or shorter, more preferably 4 hours or shorter, still more preferably 3 hours or shorter, even more preferably 2.5 hours or shorter, and particularly preferably 2 hours or shorter, from the viewpoint of the productivity.

It is preferable to further include the following step (iii) after the Na ions in the glass is subjected to ion exchange with the Ag ions in the molten salt as described above.

(iii) a step of bringing the glass sheet obtained in the step (ii) into contact with a molten salt containing Na ions, and performing ion exchange of a part of the Ag ions in the glass which has been subjected to the ion exchange in the step (ii) with the Na ions again.

In the step (iii), the Ag ions in a region having a high Ag ion concentration on the glass sheet surface are subjected to ion exchange again with the Na ions. As a result, the refractive index of the surface of the glass sheet is lowered to form a cladding portion, whereby a core portion is formed on the glass substrate.

In the case where masking is performed in the step (ii), in the step (iii), the masked glass sheet may be brought into contact with a molten salt containing Na ions to perform ion exchange of the Ag ions near the surface of a non-masked portion with Na ions. Alternatively, the masking may be eliminated, and the entire glass sheet may be brought into contact with the molten salt containing Na ions.

In the case where the step (iii) is not performed, as described above, a layer having a low refractive index may be separately provided on the upper portion of the core portion such that the core portion functions as an optical waveguide.

The molten salt used in the step (iii) may be any as long as it contains Na ions, and examples of the salt containing Na ions include NaNO₃, Na₂SO₄, Na₂CO₃, and NaCl. Among them, NaNO₃ or Na₂SO₄ is preferred from the viewpoint of the melting temperature. The salt containing Na ions may be used alone or in combination of two or more kinds thereof.

As the molten salt, a mixed molten salt obtained by mixing the salt containing Na ions with another salt may be used.

Examples of other salts include a nitrate, a sulfate, a carbonate, and a chloride. Among them, examples of the nitrate include lithium nitrate, potassium nitrate, and cesium nitrate. Examples of the sulfate include lithium sulfate, potassium sulfate, and cesium sulfate. Examples of the carbonate include lithium carbonate and potassium carbonate. Examples of the chloride include lithium chloride, potassium chloride, and cesium chloride.

Among them, a nitrate is preferably contained from the viewpoint of chemical stability.

The above salts may be used alone or in combination of plural kinds thereof.

The content of the Na ions with respect to the total amount of cations in the molten salt is preferably 60% to 100%, more preferably 70% to 99.9%, still more preferably 80% to 99.8%, even more preferably 90% to 99.7%, and particularly preferably 95% to 99.5% in terms of mass ratio. From the viewpoint of sufficiently reducing the refractive index of the glass surface, the content of the Na ions is preferably 60% or more, more preferably 70% or more, still more preferably 80% or more, even more preferably 90% or more, and particularly preferably 95% or more. The higher the content, the more preferred it may be, even up to 100%. On the other hand, the content of the Na ions is preferably 100% or less, more preferably 99.9% or less, still more preferably 99.8% or less, even more preferably 99.7% or less, and particularly preferably 99.5% or less, from the viewpoint of the productivity.

The content of the Na ions with respect to the total amount of cations in the molten salt is preferably 40% to 99.9%, more preferably 50% to 99%, still more preferably 60% to 98%, even more preferably 70% to 97%, and particularly preferably 80% to 96% in cation %.

The content of the Na ions is preferably 40% or more, more preferably 50% or more, still more preferably 60% or more, even more preferably 70% or more, and particularly preferably 80% or more, from the viewpoint of sufficiently reducing the refractive index of the glass surface. On the other hand, the content of the Na ions is preferably 99.9% or less, more preferably 99% or less, still more preferably 98% or less, even more preferably 97% or less, and particularly preferably 96% or less, from the viewpoint of the productivity.

The temperature of the molten salt is not particularly limited as long as it is equal to or higher than the melting point of the salt, and is, for example, preferably 350° C. to 490° C., more preferably 360° C. to 480° C., still more preferably 370° C. to 470° C., even more preferably 375° C. to 460° C., and particularly preferably 380° C. to 450° C. The temperature of the molten salt is preferably 350° C. or higher, more preferably 360° C. or higher, still more preferably 370° C. or higher, even more preferably 375° C. or higher, and particularly preferably 380° C. or higher, from the viewpoint of the productivity. On the other hand, the temperature of the molten salt is preferably 490° C. or lower, more preferably 480° C. or lower, still more preferably 470° C. or lower, even more preferably 460° C. or lower, and particularly preferably 450° C. or lower, from the viewpoint of having higher homogeneity and realizing the desired core thickness Δd.

The time of contact with the molten salt varies depending on the contact method, and the immersion time in the case of immersing the glass sheet in the molten salt is preferably 20 minutes to 6 hours, more preferably 30 minutes to 4 hours, still more preferably 35 minutes to 3 hours, even more preferably 40 minutes to 2.5 hours, and particularly preferably 45 minutes to 2 hours. The immersion time is preferably 20 minutes or longer, more preferably 30 minutes or longer, still more preferably 35 minutes or longer, even more preferably 40 minutes or longer, and particularly preferably 45 minutes or longer, from the viewpoint of having higher homogeneity and realizing the desired core thickness Δd. On the other hand, the immersion time is preferably 6 hours or shorter, more preferably 4 hours or shorter, still more preferably 3 hours or shorter, even more preferably 2.5 hours or shorter, and particularly preferably 2 hours or shorter, from the viewpoint of the productivity.

In performing the step (ii) or the step (iii), the glass sheet may be preheated. The preheating temperature varies depending on the temperature of the molten salt, and is preferably, for example, 100° C. or higher.

A washing step or a drying step may be performed between the step (ii) and the step (iii), after the step (ii), or after the step (iii).

In the washing step, the glass is washed using industrial water, ion exchange water, or the like. As the industrial water, water treated as necessary is used. Among them, ion exchange water is preferred.

The washing condition varies depending on a washing liquid to be used, and in the case of using ion exchange water, washing at 0° C. to 100° C. is preferred from the viewpoint of completely removing adhering salts.

In the washing step, various methods such as a method of immersing a glass sheet in a water tank containing ion exchange water or the like, a method of exposing the surface of a glass sheet to flowing water, and a method of spraying a washing liquid toward the surface of a glass sheet by a shower can be used.

### EXAMPLES

Hereinafter, the present invention is described based on specific Examples. The present invention is not limited to the following Examples.

In all of Examples 1 to 36, ion exchange was performed without masking a glass substrate, and thus the glass substrate did not include a core portion to be an optical waveguide and a cladding portion. However, the refractive index of the base glass before the ion exchange and the change in refractive index after the ion exchange can be regarded as the same as those in the case where the ion exchange is performed with masking to form the core portion to be an optical waveguide. The core thickness Δd formed by the ion exchange can also be regarded as the same as that in the case where the ion exchange is performed with masking to form the core portion to be an optical waveguide. Therefore, the results for Examples 1 to 36 can be regarded as the same as the results for the glass substrate including the core portion to be an optical waveguide and the cladding portion, and can be substantially treated as Examples or Comparative Examples. Therefore, Examples 1 to 31 are Inventive Examples, and Examples 32 to 36 are Comparative Examples.

### Production of Glass Sheet

Glass raw materials were weighed and mixed so as to have the composition shown in Tables 1 and 2 in mol % in terms of oxides and have a glass weight of 400 g. The mixed raw materials were charged into a platinum crucible, melted in an electric furnace at 1500° C. to 1700° C. for about 3 hours, defoamed, and homogenized. The blank column in the tables means that the component is not intentionally added.

The molten glass obtained above was poured into a metal mold and held at a temperature about 10° C. higher than the glass transition temperature for 1 hour. Next, the mixture was cooled to room temperature at a rate of 0.5° C./min to obtain a glass block.

The obtained glass block was cut, ground, and finally mirror-polished on both sides to obtain glass sheets G1 to G20, each being 20 mm×20 mm×0.7 mm.

Each of the glass sheets G1 to G20 was immersed in a mixed molten salt of NaNO₃:AgNO₃=99:1 (mass ratio) at 400° C. for 1 hour. At this time, the Ag ion penetration depth from the surface of the glass sheet was measured by energy dispersive X-ray spectroscopy (SEM-EDX). In the measurement, the depth at which the Ag ion concentration was substantially 0 was defined as the Ag ion penetration depth. The results are shown in “Ag ion penetration depth (μm)” in Tables 1 and 2.

TABLE 1

| (mol %) | G1 | G2 | G3 | G4 | G5 | G6 | G7 | G8 | G9 | G10 |
|---|---|---|---|---|---|---|---|---|---|---|
| SiO₂ | 70.0 | 60.0 | 67.5 | 65.0 | 62.5 | 60.0 | 65.0 | 65.0 | 55.0 | 62.5 |
| Al₂O₃ | | 10.0 | 2.5 | 5.0 | 7.5 | 5.0 | 2.5 | 5.0 | 5.0 | 7.5 |
| B₂O₃ | | | | | | | | | 10.0 | |
| MgO | 10.0 | 10.0 | 10.0 | 10.0 | 10.0 | 12.5 | 12.5 | 5.0 | 5.0 | 5.0 |
| CaO | 10.0 | 10.0 | 10.0 | 10.0 | 10.0 | 12.5 | 12.5 | | 10.0 | |
| SrO | | | | | | | | 10.0 | 5.0 | 15.0 |
| BaO | | | | | | | | 5.0 | | |
| Na₂O | 10.0 | 10.0 | 10.0 | 10.0 | 10.0 | 10.0 | 7.5 | 10.0 | 10.0 | 10.0 |
| K₂O | | | | | | | | | | |
| Total | 100.0 | 100.0 | 100.0 | 100.0 | 100.0 | 100.0 | 100.0 | 100.0 | 100.0 | 100.0 |
| (MgO + CaO + SrO × 2 + BaO × | 20.0 | 0.0 | 15.0 | 10.0 | 5.0 | 15.0 | 20.0 | 25.0 | 15.0 | 20.0 |
| 2-Al₂O₃ × 2) [%] | | | | | | | | | | |
| (MgO + CaO × 2 + SrO × 3 + | 30.0 | 10.0 | 25.0 | 20.0 | 15.0 | 27.5 | 32.5 | 45.0 | 30.0 | 35.0 |
| BaO × 4-Al₂O₃ × 2) [%] | | | | | | | | | | |
| {Na₂O/(MgO + CaO × 2 + | 0.33 | 0.33 | 0.33 | 0.33 | 0.33 | 0.27 | 0.20 | 0.18 | 0.25 | 0.20 |
| SrO × 3 + BaO × 4)} | | | | | | | | | | |
| {Na₂O/(MgO + CaO × 2 + | 0.33 | 0.50 | 0.36 | 0.40 | 0.44 | 0.31 | 0.21 | 0.20 | 0.29 | 0.24 |
| SrO × 3 + BaO × 4-Al₂O₃)} | | | | | | | | | | |
| Ag ion penetration depth (μm) | 8.7 | 25.4 | 11 | 16.5 | 20 | 9 | 6.2 | 4.7 | 4.8 | 3.7 |

TABLE 2

| (mol %) | G11 | G12 | G13 | G14 | G15 | G16 | G17 | G18 | G19 | G20 |
|---|---|---|---|---|---|---|---|---|---|---|
| SiO₂ | 60.0 | 60.0 | 50.0 | 67.5 | 57.7 | 65.0 | 65.0 | 65.0 | 57.5 | 63.0 |
| Al₂O₃ | 10.0 | 10.0 | 5.0 | 2.5 | 5.2 | 2.5 | 2.5 | 5.0 | | 11.0 |
| B₂O₃ | | 5.0 | 15.0 | | 10.5 | | | | | |
| MgO | | | 5.0 | 10.0 | | 12.5 | 5.0 | 5.0 | 10.0 | |
| CaO | | 5.0 | 10.0 | 10.0 | 3.8 | 10.0 | 5.0 | 5.0 | | 8.5 |
| SrO | 10.0 | | | | | | 7.5 | 5.0 | 15.0 | |
| BaO | 10.0 | 10.0 | | | 7.1 | | | | 10.0 | |
| Na₂O | 10.0 | 10.0 | 15.0 | 8.0 | 15.7 | 10.0 | 15.0 | 15.0 | 7.5 | 16.5 |
| K₂O | | | | 2.0 | | | | | | 1.0 |
| Total | 100.0 | 100.0 | 100.0 | 100.0 | 100.0 | 100.0 | 100.0 | 100.0 | 100.0 | 100.0 |
| (MgO + CaO + SrO × 2 + | 20.0 | 5.0 | 5.0 | 15.0 | 7.5 | 17.5 | 20.0 | 10.0 | 60.0 | −13.5 |
| BaO × 2-Al₂O₃ × 2) [%] | | | | | | | | | | |
| (MgO + CaO × 2 + SrO × | 50.0 | 30.0 | 15.0 | 25.0 | 25.4 | 27.5 | 32.5 | 20.0 | 95.0 | −5.0 |
| 3 + BaO × 4-Al₂O₃ × 2) [%] | | | | | | | | | | |
| {Na₂O/(MgO + CaO × 2 + | 0.14 | 0.20 | 0.60 | 0.27 | 0.44 | 0.31 | 0.40 | 0.50 | 0.08 | 0.97 |
| SrO × 3 + BaO × 4)} | | | | | | | | | | |
| {Na₂O/(MgO + CaO × 2 + | 0.17 | 0.25 | 0.75 | 0.29 | 0.51 | 0.33 | 0.43 | 0.60 | 0.08 | 2.75 |
| SrO × 3 + BaO × 4-Al₂O₃)} | | | | | | | | | | |
| Ag ion penetration depth (μm) | 4.5 | 5.2 | 6.5 | 18.0 | 7.7 | 9.2 | 12.3 | 17.4 | 1.4 | 80 |

### Examples 1 to 36

The glass sheets G1 to G20 obtained above were subjected to a two-stage ion exchange treatment under the conditions shown in Tables 3 to 6 to prepare glass substrates in Examples 1 to 36.

In the first-stage ion exchange treatment, a mixed molten salt of AgNO₃ and NaNO₃ was used as the Ag-containing salt. The ratios of Ag and Na to the total amount of cations in the mixed molten salt were as described in “Ag-containing salt” in the tables. The above ratio is expressed in mass % and expressed in cation % in parentheses. The glass sheet preheated to 200° C. was immersed in the molten salt of each of the Ag-containing salts. The temperature and the immersion time of the molten salt are as described in “temperature 1 (C)” and “ion exchange time (time)” in Tables 3 to 6.

After the first-stage ion exchange treatment, the glass sheet was washed with warm water at about 60° C., dried, and then subjected to the second-stage ion exchange treatment.

In the second-stage ion exchange treatment, a molten salt of NaNO₃ was used as the Na-containing salt. Therefore, the ratio of Na to the total amount of cations in the molten salt is 100%.

The glass sheet preheated to 200° C. was immersed in the molten salt of NaNO₃. The temperature and the immersion time of the molten salt are as described in “temperature 2 (° C.)” and “ion exchange time (time)” in Tables 3 to 6.

After the second-stage ion exchange treatment, the glass sheet was washed with warm water at about 60° C. and dried to obtain a glass substrate.

The ion distribution in the obtained glass substrate after the ion exchange treatment was measured from the surface to a depth of 100 μm by an electron probe microanalyzer method. The amount of Ag and the amount of Na at the point where the amount of Ag ions is the maximum in the glass can be regarded as the content of Ag₂O and the content of Na₂O in the glass of the core portion to be an optical waveguide, respectively, and are shown as “content of Ag₂O in core portion” and “content of Na₂O in core portion” in Tables 3 to 6, respectively. Other elements such as Si were not shown in the tables since the composition thereof did not change from that of the glass before the ion exchange treatment, that is, the glass to be the cladding portion.

TABLE 3

| | | Example | Example | Example | Example | Example | Example | Example | Example | Example | Example |
|---|---|---|---|---|---|---|---|---|---|---|---|
| | | 1 | 2 | 3 | 4 | 5 | 6 | 7 | 8 | 9 | 10 |
| Glass sheet | | G1 | G1 | G1 | G2 | G2 | G2 | G3 | G3 | G4 | G4 |
| First stage | Ag-containing | Ag: 10% | Ag: 10% | Ag: 10% | Ag: 10% | Ag: 20% | Ag: 20% | Ag: 10% | Ag: 10% | Ag: 20% | Ag: 20% |
| | salt | (Ag: 5%) | (Ag: 5%) | (Ag: 5%) | (Ag: 5%) | (Ag: 11%) | (Ag: 11%) | (Ag: 5%) | (Ag: 5%) | (Ag: 11%) | (Ag: 11%) |
| | | Na: 90% | Na: 90% | Na: 90% | Na: 90% | Na: 80% | Na: 80% | Na: 90% | Na: 90% | Na: 80% | Na: 80% |
| | | (Na: 95%) | (Na: 95%) | (Na: 95%) | (Na: 95%) | (Na: 89%) | (Na: 89%) | (Na: 95%) | (Na: 95%) | (Na: 89%) | (Na: 89%) |
| | Temperature 1 | 400 | 400 | 400 | 400 | 400 | 400 | 400 | 400 | 400 | 400 |
| | (° C.) | | | | | | | | | | |
| | Ion exchange | 0.75 | 2 | 4 | 1 | 1 | 0.5 | 2 | 1 | 1 | 0.5 |
| | time (hr) | | | | | | | | | | |
| Second stage | Na-containing | Na: 100% | Na: 100% | Na: 100% | Na: 100% | Na: 100% | Na: 100% | Na: 100% | Na: 100% | Na: 100% | Na: 100% |
| | salt | | | | | | | | | | |
| | Temperature 2 | 400 | 400 | 400 | 400 | 400 | 400 | 400 | 400 | 400 | 400 |
| | (° C.) | | | | | | | | | | |
| | Ion exchange | 0.5 | 0.5 | 0.5 | 0.5 | 0.5 | 0.5 | 0.5 | 0.5 | 0.5 | 0.5 |
| | time (hr) | | | | | | | | | | |
| Refractive | N | 1.525 | 1.525 | 1.525 | 1.535 | 1.535 | 1.535 | 1.527 | 1.527 | 1.529 | 1.529 |
| index of | | | | | | | | | | | |
| cladding | | | | | | | | | | | |
| portion | | | | | | | | | | | |
| Refractive | Nmax | 1.5323 | 1.5377 | 1.5416 | 1.5438 | 1.5502 | 1.5446 | 1.5397 | 1.5359 | 1.5443 | 1.5388 |
| index | | | | | | | | | | | |
| maximum | | | | | | | | | | | |
| value of core | | | | | | | | | | | |
| portion | | | | | | | | | | | |
| Refractive | Δn | 0.0073 | 0.0127 | 0.0166 | 0.0088 | 0.0152 | 0.0096 | 0.0127 | 0.0089 | 0.0153 | 0.0098 |
| index | | | | | | | | | | | |
| difference | | | | | | | | | | | |
| Core layer | Δd (μm) | 4.0 | 5.0 | 6.0 | 6.0 | 6.0 | 5.0 | 6.0 | 5.0 | 6.0 | 5.5 |
| thickness | | | | | | | | | | | |
| Propagation | (dB/cm) | 1.5 | 0.5 | 0.5 | 1.0 | 0.5 | 1.0 | 0.5 | 1.0 | 0.5 | 1.0 |
| loss amount | | | | | | | | | | | |
| of light | | | | | | | | | | | |
| Content of | (mol %) | 8.2 | 8.4 | 7.8 | 8.0 | 7.8 | 7.8 | 8.0 | 8.2 | 7.8 | 8.0 |
| Na₂O in core | | | | | | | | | | | |
| portion | | | | | | | | | | | |
| Content of | (mol %) | 1.8 | 1.6 | 2.2 | 2.0 | 2.3 | 2.2 | 2.0 | 1.8 | 2.3 | 2.0 |
| Ag₂O in core | | | | | | | | | | | |
| portion | | | | | | | | | | | |

TABLE 4

| | | Example | Example | Example | Example | Example |
|---|---|---|---|---|---|---|
| | | 11 | 12 | 13 | 14 | 15 |
| Glass sheet | | G4 | G5 | G5 | G5 | G6 |
| First stage | Ag-containing | Ag: 20% | Ag: 20% | (Na: 89%) | Ag: 20% | Ag: 20% |
| | salt | Na: 80% | Na: 80% | Ag: 20% | Na: 80% | (Ag: 11%) |
| | | (Na: 89%) | (Na: 89%) | Na: 80% | (Na: 89%) | Na: 80% |
| | | (Ag: 11%) | (Ag: 11%) | (Ag: 11%) | (Ag: 11%) | (Na: 89%) |
| | Temperature 1 | 380 | 380 | 400 | 400 | 400 |
| | (° C.) | | | | | |
| | Ion exchange | 1 | 1 | 1 | 2 | 2 |
| | time (hr) | | | | | |
| Second stage | Na-containing | Na: 100% | Na: 100% | Na: 100% | Na: 100% | Na: 100% |
| | salt | | | | | |
| | Temperature 2 | 400 | 400 | 350 | 350 | 350 |
| | (° C.) | | | | | |
| | Ion exchange | 0.5 | 0.5 | 0.5 | 0.5 | 0.5 |
| | time (hr) | | | | | |
| Refractive | N | 1.529 | 1.532 | 1.532 | 1.532 | 1.543 |
| index of | | | | | | |
| cladding | | | | | | |
| portion | | | | | | |
| Refractive | Nmax | 1.5389 | 1.5419 | 1.5599 | 1.5669 | 1.5779 |
| index maximum | | | | | | |
| value of core | | | | | | |
| portion | | | | | | |
| Refractive | Δn | 0.0099 | 0.0099 | 0.0279 | 0.0349 | 0.0349 |
| index | | | | | | |
| difference | | | | | | |
| Core layer | Δd (μm) | 5.5 | 6.0 | 5.0 | 6.0 | 4.0 |
| thickness | | | | | | |
| Propagation | (dB/cm) | 1.0 | 1.0 | 0.5 | 1.0 | 1.0 |
| loss amount of | | | | | | |
| light | | | | | | |
| Content of | (mol %) | 8.0 | 8.0 | 7.8 | 7.6 | 7.6 |
| Na₂O in core | | | | | | |
| portion | | | | | | |
| Content of | (mol %) | 2.0 | 2.0 | 2.2 | 2.4 | 2.4 |
| Ag₂O in core | | | | | | |
| portion | | | | | | |
| | | Example | Example | Example | Example | Example |
| | | 16 | 17 | 18 | 19 | 20 |
| Glass sheet | | G6 | G6 | G7 | G7 | G7 |
| First stage | Ag-containing | Ag: 10% | Ag: 10% | Ag: 10% | Ag: 10% | Ag: 20% |
| | salt | (Ag: 5%) | (Ag: 5%) | (Ag: 5%) | (Ag: 5%) | (Ag: 11%) |
| | | Na: 90% | Na: 90% | Na: 90% | Na: 90% | Na: 80% |
| | | (Na: 95%) | Na: 95% | (Na: 95%) | (Na: 95%) | (Na: 89%) |
| | Temperature 1 | 400 | 400 | 400 | 400 | 400 |
| | (° C.) | | | | | |
| | Ion exchange | 2 | 1 | 1 | 2 | 1 |
| | time (hr) | | | | | |
| Second stage | Na-containing | Na: 100% | Na: 100% | Na: 100% | Na: 100% | Na: 100% |
| | salt | | | | | |
| | Temperature 2 | 350 | 350 | 350 | 400 | 400 |
| | (° C.) | | | | | |
| | Ion exchange | 0.5 | 0.5 | 0.5 | 0.5 | 0.5 |
| | time (hr) | | | | | |
| Refractive | N | 1.543 | 1.543 | 1.538 | 1.538 | 1.538 |
| index of | | | | | | |
| cladding | | | | | | |
| portion | | | | | | |
| Refractive | Nmax | 1.5632 | 1.5591 | 1.5571 | 1.5503 | 1.5532 |
| index maximum | | | | | | |
| value of core | | | | | | |
| portion | | | | | | |
| Refractive | Δn | 0.0202 | 0.0161 | 0.0191 | 0.0123 | 0.0152 |
| index | | | | | | |
| difference | | | | | | |
| Core layer | Δd (μm) | 4.0 | 3.5 | 6.0 | 4.5 | 4.0 |
| thickness | | | | | | |
| Propagation | (dB/cm) | 0.5 | 0.5 | 0.5 | 0.5 | 0.5 |
| loss amount of | | | | | | |
| light | | | | | | |
| Content of | (mol %) | 7.7 | 7.9 | 6.0 | 6.0 | 5.8 |
| Na₂O in core | | | | | | |
| portion | | | | | | |
| Content of | (mol %) | 2.3 | 2.1 | 1.5 | 1.5 | 1.7 |
| Ag₂O in core | | | | | | |
| portion | | | | | | |

TABLE 5

| | | Example | Example | Example | Example | Example | Example |
|---|---|---|---|---|---|---|---|
| | | 21 | 22 | 23 | 24 | 25 | 26 |
| Glass sheet | | G8 | G9 | G10 | G11 | G12 | G13 |
| First stage | Ag-containing | Ag: 15% | Ag: 15% | Ag: 10% | Ag: 20% | Ag: 15% | Ag: 10% |
| | salt | (Ag: 8%) | (Ag: 8%) | (Ag: 5%) | (Ag: 11%) | (Ag: 8%) | (Ag: 5%) |
| | | Na: 85% | Na: 85% | Na: 90% | Na: 80% | Na: 85% | Na: 90% |
| | | (Na: 92%) | (Na: 92%) | (Na: 95%) | (Na: 89%) | (Na: 92%) | (Na: 95%) |
| | Temperature 1 | 400 | 400 | 400 | 400 | 400 | 400 |
| | (° C.) | | | | | | |
| | Ion exchange | 1 | 1 | 1 | 1 | 2 | 2 |
| | time (hr) | | | | | | |
| Second stage | Na-containing | Na: 100% | Na: 100% | Na: 100% | Na: 100% | Na: 100% | Na: 100% |
| | salt | | | | | | |
| | Temperature 2 | 400 | 400 | 400 | 400 | 400 | 400 |
| | (° C.) | | | | | | |
| | Ion exchange | 1 | 1 | 1 | 0.5 | 0.5 | 1 |
| | time (hr) | | | | | | |
| Refractive | N | 1.543 | 1.546 | 1.541841 | 1.558835 | 1.547128 | 1.539947 |
| index of | | | | | | | |
| cladding | | | | | | | |
| portion | | | | | | | |
| Refractive | Nmax | 1.5523 | 1.5531 | 1.5488 | 1.5737 | 1.5636 | 1.5509 |
| index | | | | | | | |
| maximum | | | | | | | |
| value of core | | | | | | | |
| portion | | | | | | | |
| Refractive | Δn | 0.0088 | 0.0072 | 0.0070 | 0.0149 | 0.0164 | 0.0110 |
| index | | | | | | | |
| difference | | | | | | | |
| Core layer | Δd (μm) | 4.0 | 4.0 | 3.8 | 3.0 | 4.0 | 5.5 |
| thickness | | | | | | | |
| Propagation | (dB/cm) | 1.0 | 1.0 | 1.0 | 0.5 | 0.5 | 0.5 |
| loss amount of | | | | | | | |
| light | | | | | | | |
| Content of | (mol %) | 7.9 | 7.9 | 7.9 | 8.0 | 8.0 | 12.0 |
| Na₂O in core | | | | | | | |
| portion | | | | | | | |
| Content of | (mol %) | 2.1 | 2.1 | 2.1 | 2.0 | 2.0 | 3.0 |
| Ag₂O in core | | | | | | | |
| portion | | | | | | | |

| | | Example | Example | Example | Example |
|---|---|---|---|---|---|
| | | 27 | 28 | 29 | 30 |
| Glass sheet | | G14 | G15 | G16 | G17 |
| First stage | Ag-containing | Ag: 10% | Ag: 10% | Ag: 15% | Ag: 10% |
| | salt | (Ag: 5%) | (Ag: 5%) | (Ag: 8%) | (Ag: 5%) |
| | | Na: 90% | Na: 90% | Na: 85% | Na: 90% |
| | | (Na: 95%) | (Na: 95%) | (Na: 92%) | (Na: 95%) |
| | Temperature 1 | 400 | 400 | 400 | 400 |
| | (° C.) | | | | |
| | Ion exchange | 1 | 1 | 1 | 1 |
| | time (hr) | | | | |
| Second stage | Na-containing | Na: 100% | Na: 100% | Na: 100% | Na: 100% |
| | salt | | | | |
| | Temperature 2 | 400 | 400 | 400 | 400 |
| | (° C.) | | | | |
| | Ion exchange | 0.5 | 0.5 | 0.5 | 0.5 |
| | time (hr) | | | | |
| Refractive | N | 1.525548 | 1.537963 | 1.530394 | 1.533 |
| index of | | | | | |
| cladding | | | | | |
| portion | | | | | |
| Refractive | Nmax | 1.5334 | 1.5504 | 1.5396 | 1.5463 |
| index | | | | | |
| maximum | | | | | |
| value of core | | | | | |
| portion | | | | | |
| Refractive | Δn | 0.0079 | 0.0125 | 0.0092 | 0.0134 |
| index | | | | | |
| difference | | | | | |
| Core layer | Δd (μm) | 6.5 | 4.1 | 6.0 | 5.0 |
| thickness | | | | | |
| Propagation | (dB/cm) | 1.5 | 0.5 | 0.5 | 0.5 |
| loss amount of | | | | | |
| light | | | | | |
| Content of | (mol %) | 6.7 | 12.6 | 8.1 | 12.0 |
| Na₂O in core | | | | | |
| portion | | | | | |
| Content of | (mol %) | 1.3 | 3.1 | 1.9 | 3.0 |
| Ag₂O in core | | | | | |
| portion | | | | | |

TABLE 6

| | | Example 31 | Example 32 | Example 33 | Example 34 | Example 35 | Example 36 |
|---|---|---|---|---|---|---|---|
| Glass sheet | | G18 | G19 | G19 | G20 | G20 | G20 |
| First stage | Ag-containing salt | Ag: 20% | Ag: 10% | Ag: 20% | Ag: 20% | Ag: 20% | Ag: 1% |
| | | (Ag: 11%) | (Ag: 5%) | (Ag: 11%) | (Ag: 11%) | (Ag: 11%) | (Ag: 0.5%) |
| | | Na: 80% | Na: 90% | Na: 80% | Na: 80% | Na: 80% | Na: 99% |
| | | (Na: 89%) | (Na: 95%) | (Na: 89%) | (Na: 89%) | (Na: 89%) | (Na: 95.5%) |
| | Temperature 1 (° C.) | 380 | 400 | 400 | 400 | 400 | 400 |
| | Ion exchange time (hr) | 1 | 1 | 4 | 1 | 1 | 0.5 |
| Second stage | Na-containing salt | Na: 100% | Na: 100% | Na: 100% | Na: 100% | Na: 100% | Na: 100% |
| | Temperature 2 (° C.) | 400 | 400 | 400 | 350 | 400 | 350 |
| | Ion exchange time (hr) | 0.5 | 1 | 4 | 0.5 | 0.5 | 0.5 |
| Refractive index of | N | 1.528 | 1.555 | 1.555 | 1.51 | 1.51 | 1.51 |
| cladding portion | | | | | | | |
| Refractive index | Nmax | 1.5476 | 1.5604 | 1.5644 | 1.5388 | 1.5199 | 1.5144 |
| maximum value of core | | | | | | | |
| portion | | | | | | | |
| Refractive index | Δn | 0.0149 | 0.0056 | 0.0095 | 0.0288 | 0.0099 | 0.0044 |
| difference | | | | | | | |
| Core layer thickness | Δd (μm) | 5.5 | 1.2 | 2.1 | 10.5 | 18.0 | 8.0 |
| Propagation loss amount | (dB/cm) | 0.5 | 10.0 | 10.0 | 7.0 | 7.0 | 8.0 |
| of light | | | | | | | |
| Content of Na₂O in core | (mol %) | 12.0 | 6.2 | 6.0 | 13.0 | 13.2 | 15.7 |
| portion | | | | | | | |
| Content of Ag₂O in core | (mol %) | 3.0 | 1.3 | 1.5 | 3.5 | 3.3 | 0.8 |
| portion | | | | | | | |

### Measurement of Refractive Index

The refractive index of the glass sheet before the ion exchange was measured as the refractive index N of the cladding portion. In the measurement, the refractive index for light having a wavelength of 589 nm was measured using an automatic refractive index measuring instrument (KPR3000, manufactured by Shimadzu Corporation).

With respect to the glass substrate obtained through the two-stage ion exchange treatment, the refractive index at the position where the refractive index was the highest was measured as the maximum value Nmax of the refractive index using a two-beam interferometer (TD-10020, manufactured by Mizojiri Optical Co., Ltd.). The position where the refractive index is the highest means a position where the maximum refractive index is observed when the refractive index is measured every 0.5 μm in the depth direction from the surface of the glass substrate. Thereafter, it was also found that the refractive index decreases as the thickness from the surface of the glass substrate increased.

The refractive index difference Δn represented by (Nmax−N) was obtained based on the Nmax and the N measured above.

The core portion is a region where the refractive index is equal to or greater than the value represented by {N+(Δn/2)}. The core layer thickness Δd of the core portion in the thickness direction of the glass substrate was obtained based on the result of measuring the refractive index in the depth direction using the two-beam interferometer (TD-10020, manufactured by Mizojiri Optical Co., Ltd.).

The refractive index N of the cladding portion, the maximum value Nmax of the refractive index in the core portion, the refractive index difference Δn, and the core layer thickness Δd are summarized in Tables 3 to 6.

### Measurement of Propagation Loss Amount of Light

The propagation loss amount of light having a wavelength of 1550 nm in the core portion was obtained using the glass substrate obtained through the two-stage ion exchange treatment. Specifically, insertion loss amounts of an optical waveguide having a waveguide length of 10 mm and an optical waveguide having a waveguide length of 22 mm were obtained. Then, the propagation loss amount per unit length was obtained by a so-called cut back method using an expression (IL22−IL10)/(2.2−1.0) (dB/cm), IL10 being the insertion loss at a length of 10 mm and IL22 being the insertion loss at a length of 22 mm. Based on the obtained results, the maximum value of the propagation loss amount of light was obtained. The results are summarized in Tables 3 to 6.

The glass substrates in Examples 1 to 31 prepared using the glass sheets G1 to G18 have a refractive index difference Δn of 0.005 or more and a core layer thickness Δd within a range of 2.5 μm to 10 μm, and thus can transmit light propagated in a single mode.

On the other hand, the glass substrates in Examples 32 and 33 have a core layer thickness Δd of less than 2.5 μm, and do not confine light in the case of a bent region as an optical waveguide. The glass substrates in Examples 34 and 35 have a core layer thickness Δd of more than 10 μm and cannot transmit light propagated in a single mode. The glass substrate in Example 36 has a low refractive index difference Δn of 0.0044 and has poor light confinement, so that light cannot be sufficiently propagated.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-013069) filed on Jan. 31, 2023, the content of which is incorporated herein by reference.

What is claimed is:

1. A glass substrate comprising:
a core portion to be an optical waveguide; and
a cladding portion,
wherein the core portion and the cladding portion both comprise a glass,
the core portion has a higher Ag concentration than the cladding portion,
a Ag concentration gradient is present from a boundary between the core portion and the cladding portion toward a region in the core portion where the Ag concentration is maximum,
the core portion is a region where a refractive index is equal to or greater than a value represented by {N+(Δn/2)}, where Δn is a refractive index difference represented by (Nmax−N), Nmax is a maximum value of a refractive index in the core portion, and N is a refractive index of the cladding portion,
the refractive index difference Δn is 0.005 or more, and
a core thickness Δd of the core portion in a thickness direction of the glass substrate is 2.5 μm to 10 μm.

2. The glass substrate according to claim 1,
wherein the glass of the cladding portion satisfies the following contents in mol % in terms of oxides: 45% to 80% of SiO₂, 0% to 15% of Al₂O₃, 0% to 20% of B₂O₃, 10% to 30% of MgO, CaO, SrO, and BaO in total, and 4.5% to 25% of Na₂O, and the glass of the core portion satisfies the following contents in mol % in terms of oxides: 45% to 80% of SiO₂, 0% to 15% of Al₂O₃, 0% to 20% of B₂O₃, 10% to 30% of MgO, CaO, SrO, and BaO in total, 0% to 20% of Na₂O, and 0.01% or more of Ag₂O.

3. The glass substrate according to claim 1, wherein the glass of the cladding portion has a value represented by (MgO+CaO+SrO×2+BaO×2−Al₂O₃×2) of 0% to 30%, using contents in mol % in terms of oxides.

4. The glass substrate according to claim 1, wherein the glass of the cladding portion has a value represented by (MgO+CaO×2+SrO×3+BaO×4−Al₂O₃×2) of 0% to 60%, using contents in mol % in terms of oxides.

5. The glass substrate according to claim 1, wherein the glass of the cladding portion has a value represented by {Na₂O/(MgO+CaO×2+SrO×3+BaO×4)} of 0.1 to 0.7, using contents in mol % in terms of oxides.

6. The glass substrate according to claim 1, wherein the glass of the cladding portion has a value represented by {Na₂O/(MgO+CaO×2+SrO×3+BaO×4−Al₂O₃)} of 0.1 to 2, using contents in mol % in terms of oxides.

7. The glass substrate according to claim 1, having a thickness of 100 μm to 2000 μm.

8. The glass substrate according to claim 1, wherein a propagation loss amount of light having a wavelength of 1200 nm to 1600 nm in the core portion is 5.0 dB/cm or less at maximum.

9. The glass substrate according to claim 1, wherein the refractive index difference Δn is 0.007 or more.

10. The glass substrate according to claim 1, wherein the core thickness Δd is 3 μm to 6 μm.

11. An optical integrated device comprising:
the glass substrate according to claim 1; and
a semiconductor substrate connected to the glass substrate,
wherein light propagated in a single mode is introduced into the semiconductor substrate via the core portion of the glass substrate.
